(19) United States
(12) Patent Application Publication
(10) Pub. No.: US 2025/0083102 A1
(43) Pub. Date: Mar. 13, 2025

(54) EXHAUST GAS PURIFICATION CATALYST

(71) Applicants: Takahiro Nishio, Nagoya-shi (JP); Takumi Tojo, Tajimi-shi (JP); Nobuyuki Takagi, Toyota-shi (JP); Sho Hoshino, Hamamatsu-shi (JP); Naoto Fujita, Hamamatsu-shi (JP); Yosuke Toda, Iwata-shi (JP); Shun Sakamoto, Iwata-shi (JP); Kengo Shimizu, Iwata-shi (JP)

(72) Inventors: Takahiro Nishio, Nagoya-shi (JP); Takumi Tojo, Tajimi-shi (JP); Nobuyuki Takagi, Toyota-shi (JP); Sho Hoshino, Hamamatsu-shi (JP); Naoto Fujita, Hamamatsu-shi (JP); Yosuke Toda, Iwata-shi (JP); Shun Sakamoto, Iwata-shi (JP); Kengo Shimizu, Iwata-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 18/793,326

(22) Filed: Aug. 2, 2024

(30) Foreign Application Priority Data
Sep. 8, 2023 (JP) 2023-145859

(51) Int. Cl. B01D 53/94; B01J 21/04; B01J 21/06; B01J 23/44; B01J 23/46; B01J 23/63; B01J 27/053; B01J 35/40; B01J 37/02; F01N 3/10; F01N 3/28

(52) U.S. Cl. CPC B01D 53/945; B01D 53/9472; B01J 21/04; B01J 21/066; B01J 23/44; B01J 23/464; B01J 23/63; B01J 27/053; B01J 35/40; B01J 37/0228; B01D 2255/1023; B01D 2255/1025; B01D 2255/2042; B01D 2255/9032; B01D 2255/908; B01D 2255/9155; B01D 2255/9202; B01D 2257/502; B01D 2257/702; B01D 2258/01; F01N 3/101; F01N 3/2803; F01N 2370/02

(57) ABSTRACT

An exhaust gas purification catalyst includes a substrate and a catalyst layer on the substrate. The catalyst layer includes lower and upper catalyst layers. The lower catalyst layer includes a powder material containing a powdered carrier, and catalyst metal particles containing Rh on the carrier. The upper catalyst layer includes an upstream catalyst layer in an upstream side in an exhaust gas flow direction, and a downstream catalyst layer in a downstream side in the exhaust gas flow direction. At least the upstream catalyst layer of the upstream and downstream catalyst layers includes a powder material containing a powdered carrier, and catalyst metal particles containing Pd on the carrier. A cumulative 50% particle size D₅₀ in a volume-based particle size distribution of the powder material included in at least the upstream catalyst layer of the upstream and downstream catalyst layers is 6 μm or more and 10 μm or less.

### CROSS REFERENCE TO RELATED APPLICATIONS

The present application claims priority from Japanese patent application JP 2023-145859 filed on Sep. 8, 2023, the entire content of which is hereby incorporated by reference into this application.

### BACKGROUND

### Description of Related Art

The present disclosure relates to an exhaust gas purification catalyst including a substrate and a catalyst layer disposed on the substrate.

### Background Art

An exhaust gas discharged from an internal combustion engine of an automobile or the like contains a harmful component, such as hydrocarbon (HC), carbon monoxide (CO), and nitrogen oxide (NOx). To remove these harmful components from the exhaust gas, an exhaust gas purification catalyst including a substrate and a catalyst layer disposed on the substrate is used. In the exhaust gas purification catalyst, the catalyst layer includes a powder material containing a powdered carrier, an oxygen storage material (OSC material) and the like, and catalyst metal particles supported on the carrier. For the catalyst metal, for example, platinum (Pt), palladium (Pd), or rhodium (Rh) is used. Among the catalyst metals, Pd having a high purification performance of HC and CO and a high thermal stability makes a large contribution to a low-temperature purification activity of an exhaust gas purification catalyst at operation start and the like of an internal combustion engine. On the other hand, in the exhaust gas purification catalyst, an oxygen storage capacity (OSC) needs to be sufficiently ensured for reducing an oxygen concentration variation in the exhaust gas to improve a purification performance especially at high temperature. From these perspectives, various kinds of techniques have been developed, and, for example, JP 2021-055628 A discloses a purification apparatus provided with a catalyst layer including a downstream catalyst layer and an upstream catalyst layer. Each of the upstream catalyst layer and the downstream catalyst layer includes a bottom layer containing Rh and a top layer containing Pd. The upstream catalyst layer has a length 30% or more and 70% or less of a total length of a substrate. The upstream top layer has a support density (a carrying density) of Pd exceeding one time and less than three times of that of the downstream top layer.

### SUMMARY

In association with introduction of emissions regulations, such as Euro7, the importance of the low-temperature purification activity of the exhaust gas purification catalyst is increasing. As a method for improving the low-temperature purification activity, it is considered to use warming-up of a catalyst by an oxidation reaction of HC and CO in Pd making a large contribution to the low-temperature purification activity. For example, as disclosed in JP 2021-055628 A, with the catalyst layer including the layer containing Pd in the top side and the layer containing Rh in the bottom side, a frequency of contact of the exhaust gas with the layer containing Pd is increased, thereby enabling the enhanced warming-up performance of the catalyst and the improved low-temperature purification activity. On the other hand, in this case, since the frequency of contact of the exhaust gas with the layer containing Rh decreases, the function of the OSC material is possibly not sufficiently provided. Therefore, especially at high temperature, the OSC possibly becomes insufficient.

The present disclosure has been made in consideration of such a situation, and provides an exhaust gas purification catalyst capable of improving a low-temperature purification activity and sufficiently ensuring an OSC.

To solve the above-described problem, an exhaust gas purification catalyst of the present disclosure comprises a substrate and a catalyst layer disposed on the substrate. The catalyst layer includes a lower catalyst layer disposed on the substrate, and an upper catalyst layer disposed on the lower catalyst layer. The lower catalyst layer includes a powder material containing a powdered carrier, and catalyst metal particles containing Rh supported on the carrier. The upper catalyst layer includes an upstream catalyst layer disposed in an upstream side in an exhaust gas flow direction, and a downstream catalyst layer disposed in a downstream side in the exhaust gas flow direction. At least the upstream catalyst layer of the upstream catalyst layer and the downstream catalyst layer includes a powder material containing a powdered carrier, and catalyst metal particles containing Pd supported on the carrier. A cumulative 50% particle size D₅₀ in a volume-based particle size distribution of the powder material included in at least the upstream catalyst layer of the upstream catalyst layer and the downstream catalyst layer is 6 μm or more and 10 μm or less.

### Effect

According to the present disclosure, the low-temperature purification activity can be improved, and the OSC can be sufficiently ensured.

### BRIEF DESCRIPTION OF THE DRAWINGS

FIG. 1 is a schematic perspective view of an exhaust gas purification catalyst according to a first embodiment;

FIG. 2 is a schematic cross-sectional view illustrating a cross section parallel to an extending direction of a cell of the exhaust gas purification catalyst illustrated in FIG. 1;

FIG. 3A is a graph illustrating a relation between D₅₀ of a mixed powder in an upstream catalyst layer and a downstream catalyst layer of an upper catalyst layer, and each of Cmax and NOx-T50;

FIG. 3B is a graph illustrating a relation between a weight proportion of Pd particles in the upstream catalyst layer, and each of Cmax and NOx-T50;

FIG. 4A is a graph illustrating a relation between a coat width of the upstream catalyst layer of the upper catalyst layer, and each of Cmax and NOx-T50; and

FIG. 4B is a graph illustrating a relation between a combination of the D₅₀ of the mixed powder of the upstream catalyst layer and the downstream catalyst layer of the upper catalyst layer, and each of Cmax and NOx-T50.

### DETAILED DESCRIPTION OF THE EMBODIMENTS

The following describes embodiments according to an exhaust gas purification catalyst of the present disclosure. In the following description, “upstream” and “downstream” mean an upstream side and a downstream side in a flow direction of an exhaust gas, respectively. An “axial direction” means an axial direction of a substrate. An “extending direction” means an extending direction of a partition wall and a cell, that is, a direction in which the upstream side is opposed to the downstream side, and means a direction approximately the same as the axial direction.

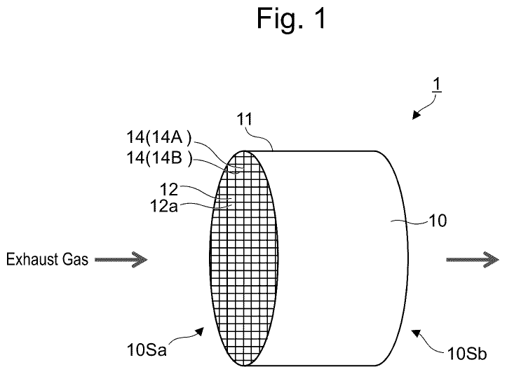

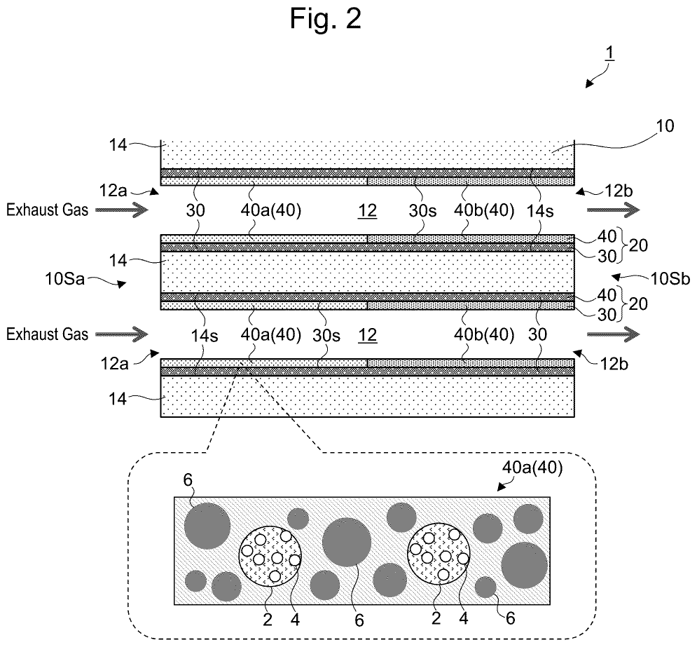

First, an outline of the embodiments will be described with a first embodiment as an example. FIG. 1 is a schematic perspective view of an exhaust gas purification catalyst according to a first embodiment. FIG. 2 is a schematic cross-sectional view illustrating a cross section parallel to an extending direction of a cell of the exhaust gas purification catalyst illustrated in FIG. 1, and illustrates an enlarged view of a cross section of an upstream catalyst layer of an upper catalyst layer of a catalyst layer together. As illustrated in FIG. 1 and FIG. 2, an exhaust gas purification catalyst 1 according to the first embodiment is what is called a straight flow type three-way catalyst. The exhaust gas purification catalyst 1 includes a honeycomb substrate 10 (substrate) and a catalyst layer 20 disposed on the honeycomb substrate 10. The honeycomb substrate 10 is a substrate in which a cylindrically-shaped frame portion 11 and a partition wall 14 that partitions a space inside the frame portion 11 in a honeycomb shape are integrally formed. The partition wall 14 is a porous body that defines a plurality of cells 12 extending from an upstream end surface 10Sa to a downstream end surface 10Sb of the honeycomb substrate 10. The partition wall 14 includes a plurality of wall portions 14A arranged to be mutually spaced and parallel and a plurality of wall portions 14B orthogonal to the plurality of wall portions 14A and arranged to be mutually spaced and parallel such that cross-sectional surfaces perpendicular to the extending direction of the plurality of cells 12 have square shapes. This provides the partition wall 14 with a grid-like cross section perpendicular to the extending direction. The plurality of cells 12 are mutually adjacent with the partition wall 14 interposed therebetween, and upstream ends 12a and downstream ends 12b thereof are open.

As illustrated in FIG. 2, the catalyst layer 20 includes a lower catalyst layer 30 and an upper catalyst layer 40. The lower catalyst layer 30 is disposed in a region from the upstream end to the downstream end of the partition wall 14 along the extending direction on a surface 14s in the cell 12 side of the partition wall 14. The upper catalyst layer 40 is disposed in a region from the upstream end to the downstream end of the partition wall 14 along the extending direction on a surface 30s of the lower catalyst layer 30. A proportion of a length in the extending direction (axial direction) of the lower catalyst layer 30 to a length in the extending direction of the partition wall 14 (length in the axial direction of the substrate) is 100%. Although not illustrated, the lower catalyst layer 30 includes a powder material that contains a powdered carrier containing carrier particles and a powdered cocatalyst containing cocatalyst particles, and catalyst metal particles containing rhodium (Rh) supported on the carrier particles. The carrier particles of the powdered carrier include carrier particles containing an OSC material and carrier particles not containing the OSC material. The cocatalyst particles of the powdered cocatalyst do not support the catalyst metal particles, and include cocatalyst particles containing the OSC material and cocatalyst particles not containing the OSC material.

The upper catalyst layer 40 includes an upstream catalyst layer 40a disposed in the upstream side in the exhaust gas flow direction, and a downstream catalyst layer 40b disposed in the downstream side in the exhaust gas flow direction. The upstream catalyst layer 40a extends to a predetermined position apart from the upstream end of the partition wall 14 toward the downstream side along the extending direction by a distance of 50% of the length in the extending direction of the partition wall 14. The downstream catalyst layer 40b extends to the predetermined position from the downstream end of the partition wall 14 along the extending direction. A proportion of a length in the extending direction (axial direction) of the upstream catalyst layer 40a to the length in the extending direction of the partition wall 14 (length in the axial direction of the substrate) is 50%. A proportion of a length in the extending direction of the downstream catalyst layer 40b to the length in the extending direction of the partition wall 14 is 50%. As illustrated in the enlarged view of FIG. 2, the upstream catalyst layer 40a and the downstream catalyst layer 40b include a powder material that contains a powdered carrier containing carrier particles 2, and a powdered cocatalyst containing cocatalyst particles 6, and catalyst metal particles 4 containing palladium (Pd) supported on the carrier particles 2. The carrier particles 2 of the powdered carrier include carrier particles containing an OSC material and carrier particles not containing the OSC material. The cocatalyst particles 6 of the powdered cocatalyst do not support the catalyst metal particles 4, and include cocatalyst particles containing the OSC material, cocatalyst particles not containing the OSC material, and additionally, cocatalyst particles containing barium sulfate. A cumulative 50% particle size D₅₀ of the powder material included in the upstream catalyst layer 40a in a volume-based particle size distribution is 6.5 μm. A D₅₀ of the powder material included in the downstream catalyst layer 40b is similarly 6.5 μm. A proportion of a weight of the catalyst metal particles included in the upstream catalyst layer 40a to a weight of the catalyst metal particles included in the upper catalyst layer 40 is 75 weight %.

In the exhaust gas purification catalyst 1 according to the first embodiment, the D₅₀ of the powder material included in the upstream catalyst layer 40a and the downstream catalyst layer 40b of the upper catalyst layer 40 is 6 μm or more. Thereby, sizes of voids in these layers can be increased to the extent equal to or more than that in a case where these layers are formed using a slurry in which an organic resin pore-forming material is added like a conventional one. As a result, to the extent equal to or more than the case of using the slurry in which the organic resin pore-forming material is added, an exhaust gas easily passes through the upstream catalyst layer 40a and the downstream catalyst layer 40b. Accordingly, by further increasing the frequency of contact of the exhaust gas with the upstream catalyst layer 40a and the downstream catalyst layer 40b containing Pd, the warming-up action by the oxidation reaction of HC and CO in Pd increases, thus enabling the improvement of the warming-up performance of the exhaust gas purification catalyst 1. Additionally, by suppressing reduction of the frequency of contact of the exhaust gas with the lower catalyst layer 30 containing Rh, the function of the OSC material can be sufficiently provided. Accordingly, the low-temperature purification activity can be improved, and the OSC can be sufficiently ensured especially at high temperature. On the other hand, the D₅₀ of the powder material included in the upstream catalyst layer 40a and the downstream catalyst layer 40b is m or less, and this enables thinning these layers. Accordingly, the increase of the pressure loss can be suppressed. When the upstream catalyst layer 40a and the downstream catalyst layer 40b are formed using the slurry in which the organic resin pore-forming material is added, heat generation by burning the pore-forming material causes a thermal stress when the substrate is fired after applying the slurry. In contrast, in the exhaust gas purification catalyst 1, since these layers can be formed without adding the pore-forming material to the slurry, the occurrence of the thermal stress can be suppressed. Accordingly, since the problem of durability can be avoided, various kinds of substrates, such as a substrate with a thin component part, can be employed as the substrate 10, thus enabling the improvement of the warming-up performance of the exhaust gas purification catalyst 1.

The proportion of the weight of the catalyst metal particles included in the upstream catalyst layer 40a to the weight of the catalyst metal particles included in the upper catalyst layer 40 is 50 weight % or more. This increases the Pd density of the upstream catalyst layer 40a where the temperature becomes relatively high, and therefore, the warming-up action by the oxidation reaction of HC and CO in Pd further increases. Accordingly, the warming-up performance of the exhaust gas purification catalyst 1 can be effectively enhanced, and the low-temperature purification activity can be further improved. On the other hand, the proportion of the weight equal to or less than 90 weight % avoids the Pd density of the downstream catalyst layer 40b from becoming excessively low, and this enables sufficiently providing the function of the OSC material included in the downstream catalyst layer 40b and a downstream region of the lower catalyst layer 30, thus allowing further sufficiently ensuring the OSC. Furthermore, the proportion of the length in the extending direction of the upstream catalyst layer 40a to the length in the extending direction of the partition wall 14 is 30% or more, and this avoids the Pd density of the downstream catalyst layer 40b from becoming excessively low, thus allowing further sufficiently ensuring the OSC. On the other hand, the proportion of the length in the extending direction of the upstream catalyst layer 40a to the length in the extending direction of the partition wall 14 is 70% or less, and this increases the Pd density of the upstream catalyst layer 40a where the temperature becomes relatively high. Therefore, the warming-up performance of the exhaust gas purification catalyst 1 can be effectively enhanced, and the low-temperature purification activity can be further improved. Next, the configuration of the exhaust gas purification catalyst according to the embodiment will be described in detail.

### 1. Substrate

While the substrate is not specifically limited, for example, a honeycomb substrate is used. While the material of the substrate is not specifically limited, for example, cordierite may be used.

### 2. Catalyst Layer

The catalyst layer includes the lower catalyst layer disposed on the substrate, and the upper catalyst layer disposed on the lower catalyst layer. While the catalyst layer is not specifically limited, for example, when the substrate is a honeycomb substrate, the lower catalyst layer is disposed on the surface in the cell side of the partition wall of the honeycomb substrate, and the upper catalyst layer is disposed on the surface of the lower catalyst layer.

### (1) Lower Catalyst Layer

The lower catalyst layer includes the powder material containing the powdered carrier and the catalyst metal particles containing rhodium (Rh) supported on the carrier.

While the powder material is not specifically limited insofar as the powdered carrier is contained, the powdered cocatalyst may be further contained. The powdered carrier and the powdered cocatalyst are similar to the powdered carrier and the powdered cocatalyst included in the upstream catalyst layer of the upper catalyst layer described later, respectively. When the material of the powdered carrier includes two kinds or more, or when the material of the powdered carrier includes one kind and the material of the powdered cocatalyst includes one kind or more, the powder material is a mixed powder containing powders of two or more kinds of materials. While the weight of the powder material of the lower catalyst layer per litter of the volume of a coated part coated with the lower catalyst layer of the substrate is not specifically limited, for example, the weight may be within a range of 30 g/L or more and 250 g/L or less. The volume of the coated part coated with each kind of catalyst layers of the substrate means a volume of a region (coated part) in the axial direction of the substrate having (with) the same length as the length in the axial direction of each kind of the catalyst layer (bulk volume including a net volume of the region and a volume of internal cells). The catalyst metal particle is not specifically limited insofar as Rh is contained. The catalyst metal particles have an average particle size similar to that of the catalyst metal particles included in the upstream catalyst layer of the upper catalyst layer described later. While the weight of the catalyst metal particles of the lower catalyst layer per litter of the volume of the coated part coated with the lower catalyst layer of the substrate is not specifically limited, for example, the weight may be within a range of 0.05 g/L or more and 5 g/L or less. While the lower catalyst layer is not specifically limited, for example, the lower catalyst layer may extend to the predetermined position apart from the downstream end of the substrate (partition wall) toward the upstream side along the axial direction (extending direction) by the distance of 80% or more and 100% or less of the length in the axial direction of the substrate.

### (2) Upper Catalyst Layer

The upper catalyst layer includes the upstream catalyst layer disposed in the upstream side in the exhaust gas flow direction and the downstream catalyst layer disposed in the downstream side in the exhaust gas flow direction. At least the upstream catalyst layer of the upstream catalyst layer and the downstream catalyst layer includes the powder material containing the powdered carrier and the catalyst metal particles containing palladium (Pd) supported on the carrier. The cumulative 50% particle size D₅₀ in the volume-based particle size distribution of the powder material included in at least the upstream catalyst layer of the upstream catalyst layer and the downstream catalyst layer is 6 μm or more and 10 μm or less. The cumulative 50% particle size D₅₀ in the volume-based particle size distribution of the powder material can be obtained by, for example, measurement using a laser diffraction particle size distribution measuring device. While the upper catalyst layer is not specifically limited, both of the upstream catalyst layer and the downstream catalyst layer may include the powder material and the catalyst metal particles. In the upper catalyst layer, the D₅₀ of the powder material included in both of the upstream catalyst layer and the downstream catalyst layer may be 6 μm or more and 10 μm or less.

While the powder material is not specifically limited insofar as the powdered carrier is contained, the powdered cocatalyst may be further contained. The powdered carrier includes carrier particles that support the catalyst metal particles. While the material of the powdered carrier is not specifically limited, examples include Al₂O₃ (alumina), CeO₂ (ceria), ZrO₂ (zirconia), and a solid solution thereof (for example, CZ composite oxide (ceria-zirconia composite oxide)), and two or more kinds of them may be used. While the material of the powdered carrier does not need to contain an OSC material, an OSC material may be contained. While the OSC material is not specifically limited, examples include CeO₂, ZrO₂, and a CZ composite oxide. The powdered cocatalyst includes cocatalyst particles not supporting the catalyst metal particles. While the material of the powdered cocatalyst is not specifically limited, examples include, in addition to the material similar to the material of the powdered carrier, alkaline earth metal sulfate, such as barium sulfate (BaSO₄), and two kinds or more of them may be used. When the material of the powdered carrier includes two kinds or more, or when the material of the powdered carrier includes one kind and the material of the powdered cocatalyst includes one kind or more, the powder material is a mixed powder containing powders of two or more kinds of materials. The D₅₀ of the powder material in this case is the D₅₀ of the mixed powder. While the weight of the powder material of the upstream catalyst layer per litter of the volume of a coated part coated with the upstream catalyst layer of the substrate or the weight of the powder material of the downstream catalyst layer per litter of the volume of the coated part coated with the downstream catalyst layer of the substrate is not specifically limited, for example, the weights may be within a range of 30 g/L or more and 250 g/L or less.

The catalyst metal particle is not specifically limited insofar as Pd is contained. The catalyst metal particle has an average particle size of, for example, 0.1 nm or more and 100 nm or less. The average particle size of the catalyst metal particles means an average value of the particle diameters obtained by, for example, a method of observing the catalyst layer with TEM or the like. In the upper catalyst layer, the proportion of the weight of the catalyst metal particles included in the upstream catalyst layer to the weight of the catalyst metal particles included in the upper catalyst layer may be 50 weight % or more and 90 weight % or less. This is because the low-temperature purification activity can be further improved, and the OSC can be further sufficiently ensured. The catalyst metal particles included in the upper catalyst layer means a sum of the catalyst metal particles included in the upstream catalyst layer and the catalyst metal particles included in the downstream catalyst layer. While the weight of the catalyst metal particles of the upstream catalyst layer per litter of the volume of the coated part coated with the upstream catalyst layer of the substrate or the weight of the catalyst metal particles of the downstream catalyst layer per litter of the volume of the coated part coated with the downstream catalyst layer of the substrate is not specifically limited, for example, the weights may be within a range of 0.05 g/L or more and 5 g/L or less.

In the upper catalyst layer, a proportion of the length in the axial direction (extending direction) of the upstream catalyst layer to the length in the axial direction of the substrate (length in the extending direction of the partition wall) may be 30% or more and 70% or less. This is because the low-temperature purification activity can be further improved, and the OSC can be further sufficiently ensured. In the upper catalyst layer, especially, the upstream catalyst layer may extend to the predetermined position apart from the upstream end of the substrate (partition wall) toward the downstream side along the axial direction (extending direction) by a distance of 30% or more and 70% or less of the length in the axial direction of the substrate, and the downstream catalyst layer may extend to the predetermined position from the downstream end of the substrate along the axial direction.

### EXAMPLES

The following further specifically describes the exhaust gas purification catalyst according to the embodiment with examples and comparative examples.

### 1. Substrate and Catalyst Layer Raw Material of Exhaust Gas Purification Catalyst

### (1) Substrate:

875 cc (600 cells, hexagon, wall thickness 2 mil) of cordierite honeycomb substrate

### (2) Catalyst Layer Raw Material:

a. Material 1 (Al₂O₃):

Powder containing particles of La₂O₃ composite Al₂O₃(La₂O₃: 1 weight % to 10 weight %)

### B. Material 2 (ACZ):

Powder containing particles of Al₂O₃—CeO₂—ZrO₂ composite oxide (CeO₂: 15 weight % to 30 weight %) (Nd₂O₃, La₂O₃, Y₂O₃ are added by a small amount, and high heat resistance is provided)

c. Material 3 (AZ):

Powder containing particles of Al₂O₃—ZrO₂ composite oxide (ZrO₂: 50 weight % to 80 weight %) (Nd₂O₃, La₂O₃, Y₂O₃ are added by a small amount, and high heat resistance is provided)

d. Material 4 (Pyrochlore Type CZ Composite Oxide):

Powder containing particles of composite oxide of 45 weight % to 55 weight %-CeO₂, 40 weight % to 50 weight %-ZrO₂, and 1 weight % to 5 weight %-Pr₆O₁₁.

e. Material 5 (Barium Sulfate):

Powder containing particles of barium sulfate

f. Material 6 (Palladium Nitrate):

Powder containing particles of palladium nitrate

g. Material 7 (Rhodium Nitrate):

Powder containing particles of rhodium nitrate

h. Material 8 (AZ Supporting Rh):

Powder containing particles of AZ on which Rh particles are supported

i. Material 9 (Al₂O₃ Supporting Pd):

Powder containing particles of Al₂O₃ on which Pd particles are supported

j. Material 10 (ACZ Supporting Pd):

Powder containing particles of ACZ on which Pd particles are supported

### 2. Production of Exhaust Gas Purification Catalyst

### Comparative Example 1

### (Formation of Lower Catalyst Layer of Catalyst Layer)

First, the material 7 and the material 3 were introduced into distilled water while being stirred, and a firing was performed after drying, thus preparing the material 8. Subsequently, the material 8, the material 1, the material 2, the material 4, and Al₂O₃-based binder were introduced into distilled water while being stirred, thus preparing a suspended slurry 1. At this time, the cumulative 50% particle size D₅₀ in the volume-based particle size distribution of a mixed powder in which the material 3 (powdered carrier), the material 1 (powdered cocatalyst), the material 2 (powdered cocatalyst), and the material 4 (powdered cocatalyst) in the slurry 1 were mixed (cumulative 50% particle size D₅₀ in the volume-based particle size distribution of the powder material included in the lower catalyst layer) was adjusted to 5.0 μm.

Subsequently, the slurry 1 was poured into the cells of the substrate from the downstream end, and an unnecessary portion was blown off by a blower to coat the cell side surface of the partition wall of the substrate with the material of the lower catalyst layer, thus preparing a precursor layer of the lower catalyst layer. At this time, per litter of the volume of the coated part coated with the lower catalyst layer of the substrate, the weight of the material 7 in Rh conversion was set to 0.25 g/L-zone, the weight of the material 1 was set to 30 g/L-zone, the weight of the material 2 was set to 60 g/L-zone, the weight of the material 3 was set to 30 g/L-zone, and the weight of the material 4 was set to 5 g/L-zone. Further, the proportion of the length in the extending direction (axial direction) of the precursor layer of the lower catalyst layer to the length in the extending direction of the partition wall (length in the axial direction of the substrate) (hereinafter abbreviated as a “lower catalyst layer coat width (proportion)” in some cases) was set to 100%. Finally, after the water content was reduced for two hours with a dryer kept at 120° C., two hours of firing was performed with an electric furnace kept at 500° C., thus forming the lower catalyst layer on the cell side surface of the partition wall of the substrate.

### (Formation of Upstream Catalyst Layer of Upper Catalyst Layer of Catalyst Layer)

Subsequently, the material 6, the material 1, the material 2, the material 5, and Al₂O₃-based binder were introduced into distilled water while being stirred, thus preparing a suspended slurry 2. At this time, the material 9 was prepared from the material 6 and the material 1, and the material 10 was prepared from the material 6 and the material 2. The cumulative 50% particle size D₅₀ in the volume-based particle size distribution of a mixed powder in which the material 1 (powdered carrier), the material 2 (powdered carrier), and the material 5 (powdered cocatalyst) in the slurry 2 were mixed (cumulative 50% particle size D₅₀ in the volume-based particle size distribution of the powder material included in the upstream catalyst layer) was adjusted to 5.0 μm.

Subsequently, the slurry 2 was poured into the cells of the substrate from the upstream end, and an unnecessary portion was blown off by a blower to coat the surface of the lower catalyst layer with the material of the upstream catalyst layer of the upper catalyst layer, thus preparing a precursor layer of the upstream catalyst layer. At this time, per litter of the volume of the coated part coated with the upstream catalyst layer of the substrate, the weight of the material 6 in Pd conversion was set to 2.25 g/L-zone, the weight of the material 1 was set to 25 g/L-zone, the weight of the material 2 was set to 75 g/L-zone, and the weight of the material 5 was set to 15 g/L-zone. Further, the proportion of the length in the extending direction of the precursor layer of the upstream catalyst layer to the length in the extending direction of the partition wall (hereinafter abbreviated as an “upstream catalyst layer coat width (proportion)” in some cases) was set to 50%. Finally, the water content was reduced and firing was performed similarly to the formation of the lower catalyst layer, thus forming the upstream catalyst layer on the surface of the lower catalyst layer.

### (Formation of Downstream Catalyst Layer of Upper Catalyst Layer of Catalyst Layer)

Subsequently, the material 6, the material 1, the material 2, the material 5, and Al₂O₃-based binder were introduced into distilled water while being stirred, thus preparing a suspended slurry 3. At this time, the material 9 was prepared from the material 6 and the material 1, and the material 10 was prepared from the material 6 and the material 2. The cumulative 50% particle size D₅₀ in the volume-based particle size distribution of a mixed powder in which the material 1 (powdered carrier), the material 2 (powdered carrier), and the material 5 (powdered cocatalyst) in the slurry 3 were mixed (cumulative 50% particle size D₅₀ in the volume-based particle size distribution of the powder material included in the downstream catalyst layer) was adjusted to 5.0 μm.

Subsequently, the slurry 3 was poured into the cells of the substrate from the downstream end, and an unnecessary portion was blown off by a blower to coat the surface of the lower catalyst layer with the material of the downstream catalyst layer of the upper catalyst layer, thus preparing a precursor layer of the downstream catalyst layer. At this time, per litter of the volume of the coated part coated with the downstream catalyst layer of the substrate, the weight of the material 6 in Pd conversion was set to 0.75 g/L-zone, the weight of the material 1 was set to 25 g/L-zone, the weight of the material 2 was set to 75 g/L-zone, and the weight of the material 5 was set to 15 g/L-zone. Further, the proportion of the length in the extending direction of the precursor layer of the downstream catalyst layer to the length in the extending direction of the partition wall (hereinafter abbreviated as a “downstream catalyst layer coat width (proportion)” in some cases) was set to 50%. Finally, the water content was reduced and firing was performed similarly to the formation of the lower catalyst layer, thus forming the downstream catalyst layer on the surface of the lower catalyst layer. Thus, the exhaust gas purification catalyst was produced.

### Example 1

The D₅₀ of the mixed powder was adjusted to 6.5 μm when the slurry 2 was prepared in the formation of the upstream catalyst layer of the upper catalyst layer of the catalyst layer. The D₅₀ of the mixed powder was adjusted to 6.5 μm when the slurry 3 was prepared in the formation of the downstream catalyst layer of the upper catalyst layer of the catalyst layer. Excluding these points, an exhaust gas purification catalyst was produced similarly to Comparative Example 1. Note that the exhaust gas purification catalyst of Example 1 is an example of the exhaust gas purification catalyst according to the first embodiment.

### Example 2

The D₅₀ of the mixed powder was adjusted to 8.0 μm when the slurry 2 was prepared in the formation of the upstream catalyst layer of the upper catalyst layer of the catalyst layer. The D₅₀ of the mixed powder was adjusted to 8.0 μm when the slurry 3 was prepared in the formation of the downstream catalyst layer of the upper catalyst layer of the catalyst layer. Excluding these points, an exhaust gas purification catalyst was produced similarly to Comparative Example 1.

### Example 3

The D₅₀ of the mixed powder was adjusted to 10.0 μm when the slurry 2 was prepared in the formation of the upstream catalyst layer of the upper catalyst layer of the catalyst layer. The D₅₀ of the mixed powder was adjusted to 10.0 μm when the slurry 3 was prepared in the formation of the downstream catalyst layer of the upper catalyst layer of the catalyst layer. Excluding these points, an exhaust gas purification catalyst was produced similarly to Comparative Example 1.

### Comparative Example 2

The D₅₀ of the mixed powder was adjusted to 12.0 μm when the slurry 2 was prepared in the formation of the upstream catalyst layer of the upper catalyst layer of the catalyst layer. The D₅₀ of the mixed powder was adjusted to 12.0 μm when the slurry 3 was prepared in the formation of the downstream catalyst layer of the upper catalyst layer of the catalyst layer. Excluding these points, an exhaust gas purification catalyst was produced similarly to Comparative Example 1.

### Example 4

In the formation of the upstream catalyst layer of the upper catalyst layer of the catalyst layer, when the slurry 2 was prepared, the amount of introducing the material 6 was reduced to set the weight in Pd conversion of the material 6 per litter of the volume of the coated part coated with the upstream catalyst layer of the substrate to 0.75 g/L-zone and adjust the D₅₀ of the mixed powder to 8.0 μm. In the formation of the downstream catalyst layer of the upper catalyst layer of the catalyst layer, when the slurry 3 was prepared, the amount of introducing the material 6 was increased to set the weight in Pd conversion of the material 6 per litter of the volume of the coated part coated with the downstream catalyst layer of the substrate to 2.25 g/L-zone and adjust the D₅₀ of the mixed powder to 8.0 μm. Excluding these points, an exhaust gas purification catalyst was produced similarly to Comparative Example 1.

### Example 5

In the formation of the upstream catalyst layer of the upper catalyst layer of the catalyst layer, when the slurry 2 was prepared, the amount of introducing the material 6 was increased to set the weight in Pd conversion of the material 6 per litter of the volume of the coated part coated with the upstream catalyst layer of the substrate to 2.70 g/L-zone and adjust the D₅₀ of the mixed powder to 8.0 μm. In the formation of the downstream catalyst layer of the upper catalyst layer of the catalyst layer, when the slurry 3 was prepared, the amount of introducing the material 6 was reduced to set the weight in Pd conversion of the material 6 per litter of the volume of the coated part coated with the downstream catalyst layer of the substrate to 0.30 g/L-zone and adjust the D₅₀ of the mixed powder to 8.0 μm. Excluding these points, an exhaust gas purification catalyst was produced similarly to Comparative Example 1.

### Example 6

In the formation of the upstream catalyst layer of the upper catalyst layer of the catalyst layer, when the slurry 2 was prepared, the amount of introducing the material 6 was increased to set the weight in Pd conversion of the material 6 per litter of the volume of the coated part coated with the upstream catalyst layer of the substrate to 3.00 g/L-zone and adjust the D₅₀ of the mixed powder to 8.0 μm. In the formation of the downstream catalyst layer of the upper catalyst layer of the catalyst layer, when the slurry 3 was prepared, the material 6 was not introduced to set the weight in Pd conversion of the material 6 per litter of the volume of the coated part coated with the downstream catalyst layer of the substrate to 0.00 g/L-zone and adjust the D₅₀ of the mixed powder to 8.0 μm. Excluding these points, an exhaust gas purification catalyst was produced similarly to Comparative Example 1.

### Example 7

In the formation of the upstream catalyst layer of the upper catalyst layer of the catalyst layer, when the slurry 2 was prepared, the D₅₀ of the mixed powder was adjusted to 8.0 μm, and the upstream catalyst layer coat width was set to 20%. In the formation of the downstream catalyst layer of the upper catalyst layer of the catalyst layer, when the slurry 3 was prepared, the D₅₀ of the mixed powder was adjusted to 8.0 μm, and the downstream catalyst layer coat width was set to 80%. Excluding these points, an exhaust gas purification catalyst was produced similarly to Comparative Example 1.

### Example 8

In the formation of the upstream catalyst layer of the upper catalyst layer of the catalyst layer, when the slurry 2 was prepared, the D₅₀ of the mixed powder was adjusted to 8.0 μm, and the upstream catalyst layer coat width was set to 35%. In the formation of the downstream catalyst layer of the upper catalyst layer of the catalyst layer, when the slurry 3 was prepared, the D₅₀ of the mixed powder was adjusted to 8.0 μm, and the downstream catalyst layer coat width was set to 65%. Excluding these points, an exhaust gas purification catalyst was produced similarly to Comparative Example 1.

### Example 9

In the formation of the upstream catalyst layer of the upper catalyst layer of the catalyst layer, when the slurry 2 was prepared, the D₅₀ of the mixed powder was adjusted to 8.0 μm, and the upstream catalyst layer coat width was set to 65%. In the formation of the downstream catalyst layer of the upper catalyst layer of the catalyst layer, when the slurry 3 was prepared, the D₅₀ of the mixed powder was adjusted to 8.0 μm, and the downstream catalyst layer coat width was set to 35%. Excluding these points, an exhaust gas purification catalyst was produced similarly to Comparative Example 1.

### Example 10

In the formation of the upstream catalyst layer of the upper catalyst layer of the catalyst layer, when the slurry 2 was prepared, the D₅₀ of the mixed powder was adjusted to 8.0 μm, and the upstream catalyst layer coat width was set to 80%. In the formation of the downstream catalyst layer of the upper catalyst layer of the catalyst layer, when the slurry 3 was prepared, the D₅₀ of the mixed powder was adjusted to 8.0 μm, and the downstream catalyst layer coat width was set to 20%. Excluding these points, an exhaust gas purification catalyst was produced similarly to Comparative Example 1.

### Example 11

The D₅₀ of the mixed powder was adjusted to 8.0 μm when the slurry 2 was prepared in the formation of the upstream catalyst layer of the upper catalyst layer of the catalyst layer. Excluding this point, an exhaust gas purification catalyst was produced similarly to Comparative Example 1.

### Comparative Example 3

The D₅₀ of the mixed powder was adjusted to 8.0 μm when the slurry 3 was prepared in the formation of the downstream catalyst layer of the upper catalyst layer of the catalyst layer. Excluding this point, an exhaust gas purification catalyst was produced similarly to Comparative Example 1.

### 3. Durability Test

For the respective exhaust gas purification catalysts of the comparative examples and the examples, a durability test was conducted using an actual engine. Specifically, the durability test was performed by mounting each of the exhaust gas purification catalysts on the exhaust system of a V8 engine and repeatedly flowing exhaust gases in respective atmospheres of stoichiometric and lean at each certain period of time (ratio of 3:1) at a catalyst bed temperature of 900° C. and over 50 hours.

### 4. Performance Evaluation

For the respective exhaust gas purification catalysts of the comparative examples and the examples after the durability test, a performance evaluation was conducted using an actual engine. Specifically, each of the exhaust gas purification catalysts was mounted on the exhaust system of an L4 engine (In-line 4-cylinder engine), and the oxygen storage capacity (OSC), the low-temperature purification activity, and the pressure loss were evaluated as described below, thereby examining the relation between the configuration and the performance for the exhaust gas purification catalysts of the comparative examples and the examples.

### [Osc]

An exhaust gas having an inlet gas temperature at 600° C. and an inlet gas atmosphere in which A/F oscillates between 14.1 and 15.1 in short cycles was supplied to each of the exhaust gas purification catalysts. In this case, from a difference between a stoichiometric point and an output of an A/F sensor, an excess or shortage of oxygen was calculated by the equation: OSC [g]=0.23× ΔA/F×injection fuel amount, and Cmax (maximum oxygen storage amount) [g] was obtained. The results are shown in Table 1 below.

### [Low-Temperature Purification Activity]

While an exhaust gas having the inlet gas atmosphere with A/F of 14.4 was flowed to each of the exhaust gas purification catalysts at Ga=30 g/s, the inlet gas temperature was gradually increased from 200° C. to 500° C. In this case, the NOx concentrations of the inlet gas and an outlet gas were measured at each inlet gas temperature to calculate the NOx conversion rate, and the inlet gas temperature when NOx was converted by 50% was measured as NOx-T50 (NOx 50% conversion temperature) [° C.]. The results are shown in Table 1 below.

### [Pressure Loss]

For each of the exhaust gas purification catalysts, the pressure loss when air was flowed through the exhaust gas purification catalyst was measured.

TABLE 1

| | Catalyst Configuration | | | | | | | |
|---|---|---|---|---|---|---|---|---|
| | | | Weight proportion of | | | | | |
| | Volume-based D₅₀ of mixed powder | | Pd particles of | | Coat width of each layer | | | |
| | of each layer of | | each layer of | | of upper | | | |
| | upper catalyst layer | | upper catalyst layer | | catalyst layer | | | |
| | D₅₀ of mixed | D₅₀ of mixed | Weight | Weight | Coat | Coat | | |
| | powder | powder of | proportion of | proportion of | width of | width of | | |
| | of upstream | downstream | Pd particles of | Pd particles of | upstream | downstream | | |
| | catalyst | catalyst | upstream | downstream | catalyst | catalyst | | |
| | layer | layer | catalyst | catalyst | layer | layer | Performance | |
| | (slurry 2) | (slurry 3) | layer (slurry 2) | layer (slurry 3) | (slurry 2) | (slurry 3) | Cmax | NOx-T50 |
| | [μm] | [μm] | [weight %] | [weight %] | [%] | [%] | [g] | [° C.] |
| Comparative Example 1 | 5.0 | 5.0 | 75% | 25% | 50 | 50 | 0.205 | 380.5 |
| Example 1 | 6.5 | 6.5 | 75% | 25% | 50 | 50 | 0.247 | 375.2 |
| Example 2 | 8.0 | 8.0 | 75% | 25% | 50 | 50 | 0.258 | 378.1 |
| Example 3 | 10.0 | 10.0 | 75% | 25% | 50 | 50 | 0.271 | 370.0 |
| Comparative Example 2 | 12.0 | 12.0 | 75% | 25% | 50 | 50 | 0.274 | 376.6 |
| Example 4 | 8.0 | 8.0 | 25% | 75% | 50 | 50 | 0.251 | 387.5 |
| Example 5 | 8.0 | 8.0 | 90% | 10% | 50 | 50 | 0.267 | 376.7 |
| Example 6 | 8.0 | 8.0 | 100% | 0% | 50 | 50 | 0.214 | 373.8 |
| Example 7 | 8.0 | 8.0 | 75% | 25% | 20 | 80 | 0.220 | 375.5 |
| Example 8 | 8.0 | 8.0 | 75% | 25% | 35 | 65 | 0.224 | 376.2 |
| Example 9 | 8.0 | 8.0 | 75% | 25% | 65 | 35 | 0.266 | 382.2 |
| Example 10 | 8.0 | 8.0 | 75% | 25% | 80 | 20 | 0.272 | 389.2 |
| Example 11 | 8.0 | 5.0 | 75% | 25% | 50 | 50 | 0.245 | 379.2 |
| Comparative Example 3 | 5.0 | 8.0 | 75% | 25% | 50 | 50 | 0.211 | 380.0 |

* Values out of range of the present disclosure are underlined.

### [Relation Between Catalyst Configuration and Performance]

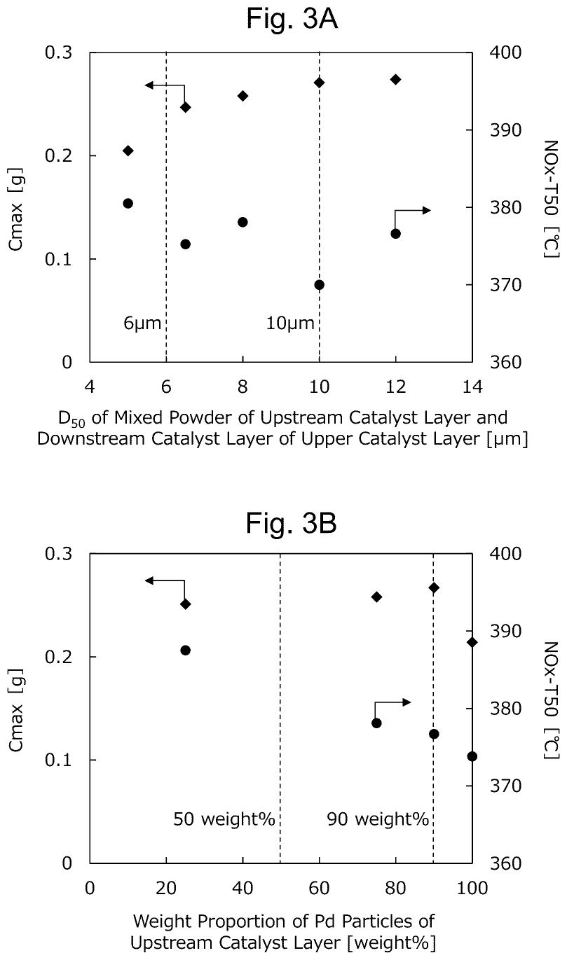

Based on the results of the performance evaluation described above, for the exhaust gas purification catalysts of Examples 1 to 3 and Comparative Examples 1 and 2, the relation between the D₅₀ of the mixed powder in the upstream catalyst layer (slurry 2) and the downstream catalyst layer (slurry 3) of the upper catalyst layer, and each of Cmax and NOx-T50 was examined. The results are shown in FIG. 3A. Further, for the exhaust gas purification catalysts of Examples 1 to 3 and Comparative Examples 1 and 2, the relation between the D₅₀ of the mixed powder of the upstream catalyst layer and the downstream catalyst layer of the upper catalyst layer and the pressure loss was examined. As illustrated in FIG. 3A, there was a tendency that as the D₅₀ of the mixed powder of the upstream catalyst layer and the downstream catalyst layer of the upper catalyst layer increased, Cmax increased, and NOx-T50 decreased. It is considered that when the D₅₀ is 6 μm or more, the effects of both of the Cmax improvement and the NOx-T50 reduction are sufficiently provided. Furthermore, from the examination result of the relation between the D₅₀ and the pressure loss, it was found that the D₅₀ of 10 μm or less can suppress the pressure loss to the extent that the merchantability of the exhaust gas purification catalyst is ensured.

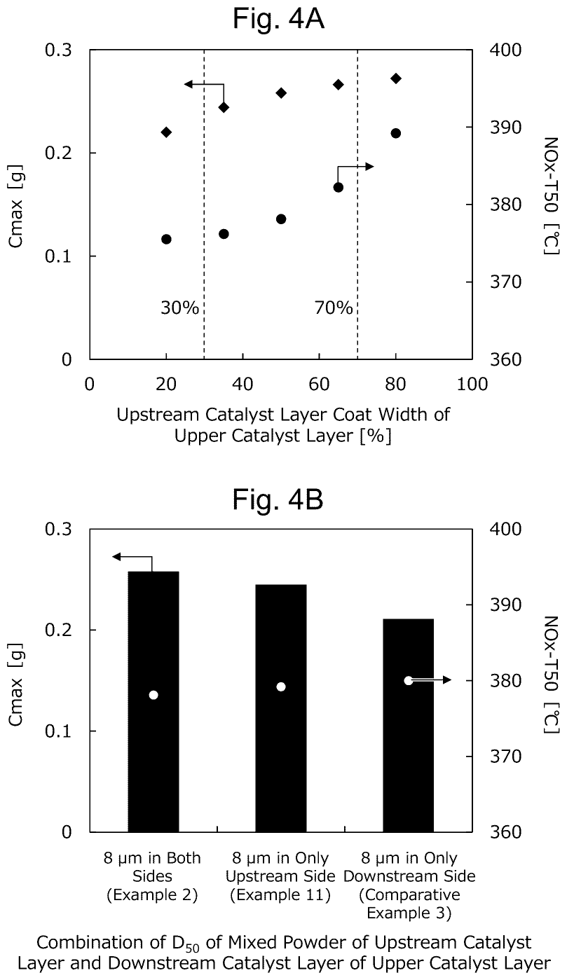

For the exhaust gas purification catalysts of Examples 2, and 4 to 6, the relation between the proportion of the weight of Pd particles contained in the upstream catalyst layer to the weight of Pd particles contained in the upper catalyst layer, and each of Cmax and NOx-T50 was examined. The results are shown in FIG. 3B. As illustrated in FIG. 3B, there was a tendency that as the weight proportion of the Pd particles in the upstream catalyst layer increased, NOx-T50 decreased, and Cmax was higher in the case where the weight proportion of the Pd particles in the upstream catalyst layer was 90 weight % or less than in the case where the weight proportion of the Pd particles in the upstream catalyst layer was more than 90 weight %. It is considered that when the weight proportion of the Pd particles in the upstream catalyst layer is 50 weight % or more and 90 weight % or less, the effects of both of the Cmax improvement and the NOx-T50 reduction are provided at a high level. For the exhaust gas purification catalysts of Examples 2, and 7 to 10, the relation between the upstream catalyst layer coat width of the upper catalyst layer, and each of Cmax and NOx-T50 was examined. The results are shown in FIG. 4A. As illustrated in FIG. 4A, there was a tendency that as the upstream catalyst layer coat width increased, Cmax increased, and as the upstream catalyst layer coat width decreased, NOx-T50 decreased. It is considered that when the coat width of the upstream catalyst layer is 30% or more and 70% or less, the effects of both of the Cmax improvement and the NOx-T50 reduction are provided at a high level. Furthermore, for the exhaust gas purification catalysts of Examples 2 and 11, and Comparative Example 3, the relation between the combination of the D₅₀ of the mixed powder of the upstream catalyst layer and the downstream catalyst layer of the upper catalyst layer, and each of Cmax and NOx-T50 was examined. The results are shown in FIG. 4B. As illustrated in FIG. 4B, in Example 2 in which both the upstream catalyst layer and the downstream catalyst layer had the D₅₀ of 8 μm, Cmax became higher and NOx-T50 became lower than Example 11 in which only the D₅₀ of the upstream catalyst layer was 8 μm and the D₅₀ of the downstream catalyst layer was 5 μm. Further, in Example 11, Cmax became higher and NOx-T50 became lower than Comparative Example 3 in which only the D₅₀ of the downstream catalyst layer was 8 μm and the D₅₀ of the upstream catalyst layer was 5 μm. It is considered that when the D₅₀ of the upstream catalyst layer is larger than the D₅₀ of the downstream catalyst layer, contribution to the Cmax improvement and the NOx-T50 reduction became large.

While the embodiment according to the present disclosure has been described in detail, the present disclosure is not limited to the above-described embodiment, and various kinds of changes of design can be made without departing from the spirits of the present disclosure described in the claims.

All publications, patents and patent applications cited in the present description are herein incorporated by reference as they are.

### DESCRIPTION OF SYMBOLS

1 Exhaust gas purification catalyst
10 Honeycomb substrate
12 Cell
14 Partition wall
20 Catalyst layer
30 Lower catalyst layer
40 Upper catalyst layer
40a Upstream catalyst layer
40b Downstream catalyst layer

What is claimed is:

1. An exhaust gas purification catalyst comprising:
a substrate; and
a catalyst layer disposed on the substrate,
wherein the catalyst layer includes a lower catalyst layer disposed on the substrate, and an upper catalyst layer disposed on the lower catalyst layer,
wherein the lower catalyst layer includes a powder material containing a powdered carrier, and catalyst metal particles containing Rh supported on the carrier,
wherein the upper catalyst layer includes an upstream catalyst layer disposed in an upstream side in an exhaust gas flow direction, and a downstream catalyst layer disposed in a downstream side in the exhaust gas flow direction,
wherein at least the upstream catalyst layer of the upstream catalyst layer and the downstream catalyst layer includes a powder material containing a powdered carrier, and catalyst metal particles containing Pd supported on the carrier, and
wherein a cumulative 50% particle size D₅₀ in a volume-based particle size distribution of the powder material included in at least the upstream catalyst layer of the upstream catalyst layer and the downstream catalyst layer is 6 μm or more and 10 μm or less.

2. The exhaust gas purification catalyst according to claim 1,
wherein a proportion of a weight of the catalyst metal particles included in the upstream catalyst layer to a weight of the catalyst metal particles included in the upper catalyst layer is 50 weight % or more and 90 weight % or less.

3. The exhaust gas purification catalyst according to claim 1,
wherein a proportion of a length in an axial direction of the upstream catalyst layer to a length in the axial direction of the substrate is 30% or more and 70% or less.
